(19) United States
(12) Patent Application Publication
(10) Pub. No.: US 2018/0220338 A1
(43) Pub. Date: Aug. 2, 2018

(54) COMMUNICATION SYSTEM, TERMINAL, BASE STATION, AND COMMUNICATION CONTROL METHOD

(71) Applicant: NEC CORPORATION, Tokyo (JP)

(72) Inventor: Takashi TABE, Tokyo (JP)

(73) Assignee: NEC CORPORATION, Tokyo (JP)

(21) Appl. No.: 15/748,259

(22) PCT Filed: Jul. 31, 2015
(86) PCT No.: PCT/JP2015/071893

§ 371 Date: Jan. 29, 2018

(51) Int. Cl. H04W 36/00; H04W 48/18; H04W 16/32; H04W 88/06; H04W 68/02

(52) U.S. Cl. CPC H04W 36/0022; H04W 48/18; H04W 16/32; H04W 12/06; H04W 68/02; H04W 36/0077; H04W 36/0027; H04W 88/06

(57) ABSTRACT

A communication system provided with a radio access network including a plurality of RATs, comprises: a first RAT for an initial access by a terminal; and at least one individual RAT different from the first RAT, wherein in accordance with a service provided to the terminal, switching from the first RAT to the individual RAT is performed for subsequent processing after the initial access, in accordance with a service to be provided to the terminal.

### CROSS REFERENCE TO RELATED APPLICATIONS

This application is a National Stage of International Application No. PCT/JP2015/071893 filed Jul. 31, 2015, the contents of all of which are incorporated herein by reference in their entirety. The present invention relates to a communication system, a terminal, a base station, and a communication control method.

### FIELD

### Background

In the 5th generation mobile communication network (hereinafter abbreviated as “5G”), a real network service of which is expected to start in 2020, it is forecasted that all communication services will be incorporated into a mobile communication network. As a background of this forecasting, it can be cited that the incorporation of all communication services into the mobile communication network would enable cost reduction of facilities and maximization of a coverage area, due to large-scale capital investment by an operator business based on subscriber revenue, and economy of scale (a management theorem, also called scale merit, stating “the larger a company size, and a business scale, the better an efficiency and the more reduced a per-unit cost”).

For example, such services as an ultra low delay (ultra low latency) communication service that can be used for industrial communications, and an IoT (Internet of Things)/M2M (Machine-to-Machine) service that accommodates a large number of sensor nodes, are supposed to be provided by a mobile communication network. For this reason, a wide range of performance is required for a 5G network.

Regarding a radio access technology (RAT) of 5G, studies are in progress in METIS (Mobile and wireless communications Enablers for the Twenty-twenty (2020) Information Society), ARIB (Association of Radio Industries and Businesses) and so forth, and related white papers have been published (Non-Patent Literatures 1 and 2).

In 3GPP (Third Generation Partnership Project) TSG (technical specification group)-RAN (Radio Access Network), a workshop on radio technology was held in September 2015, and discussion is likely to be full-fledged.

For example, as a specific example of a performance required for a 5G network, the following may be listed:
Data communication speed;
Power saving performance;
Scalability;
Ultra low delay (ultra low latency), and so forth.

As a resource constituting the radio access technology (RAT), for example, the following may be listed:
Available frequency bandwidth;
Location registration area;
Paging channel;
Random access channel;
Broadcast information, and so forth.

Here, in a location registration area (for example, in case of LTE (Long Term Evolution), a Tracking Area (TA), and in case of GERAN (GSM (Global System for Mobile communications) EDGE Radio Access Network) and UTRAN (UMTS (Universal Mobile Telecommunications System) Terrestrial Radio Access Network), a Routing Area (RA)) is an area that serves as a unit for controlling registration of a current location of a terminal in an HSS (Home Subscriber Server) and an MME (Mobility Management Entity)/HLR (Home Location Register). A network that has received a call from a terminal performs simultaneous calling (paging) in an area where a terminal of a connection destination of the call is registered. A base station performs broadcasting of a location code indicating a number of a location registration area using a signal in a downlink direction (from a base station to a mobile station) of a broadcast channel (Broadcast Control Channel: BCCH), for example. When the mobile station reaches an area of a base station which broadcasts a location code different from a currently registered position code, the mobile station automatically performs location registration update (TAU (TA Update) or RAU (RA Update)).

A paging channel is a channel for transmitting information to all terminals within an area (for example, a cell) of a radio base station and is one of control channels.

In such a case as when a terminal makes a call from an idle state (for example, a first access from an RRC (Radio Resource Control) idle state), when a terminal re-establishes an RRC Connection, when the terminal makes a handover, or the like, that is, when the terminal establishes a connection with a base station, the terminal performs a random access procedure. It is noted that RRC is a third layer protocol for controlling radio resources. The terminal transmits a PRACH preamble (a specific pattern, also called a signature, 64 preamble patterns are prepared for an LTE cell, for example), using a random access channel.

Regarding a wireless access technology, for example, Patent Literature 1 discloses a technique in which a mobile terminal capable of being in a standby state and performing communication on cells of a plurality of different radio access technologies (RAT), as a configuration for enabling a selection of a cell out of a plurality of different RATs in consideration of an operation state of the mobile terminal, may select a plurality of different RATs and be in a standby state, and then performs connection processing for communication to a base station of a RAT, to which a cell selected from a plurality of RATs belongs.

Patent Literature 2 discloses the following: In a cellular system such as LTE (Rel. 8), a successor system of LTE (Rel. 9, Rel. 10), or the like, a radio communication system (radio interface) to support a wide coverage is designed ,and in future, in addition to such a cellular environment, it is expected to provide a high-speed wireless service by local area short-range communication such as indoor, in a shopping mall and so forth, and a design of a radio communication scheme customized to the high-speed wireless service in a local area has been demanded. By utilizing wide area control information used in a wireless communication scheme optimal for a wide area, as a wireless communication scheme optimal for a local area, the local area is incorporated into a wide area so as to prevent a mobile terminal from being conscious of a difference between cells.

Patent Literature 3 discloses a configuration in which a terminal selects an appropriate RAT (for example, a power-saving RAT) according to a remaining battery level and an operation state of the terminal, from among a plurality of RAT cells different to each other.

[Patent Literature 1] JP patent Kokai Publication No. JP2014-045445A

[Patent Literature 2] JP patent Kokai Publication No. JP2013-106144A

[Patent Literature 3] U.S. Patent Application Publication No. US2014/0066068A1

[Non-Patent Literature 1] “METIS: Mobile Communications for 2020 and beyond” Internet [Search on Jul. 1, 2015] <URL: https://www.metis2020.com/wp-content/uploads/publications/VDE_ITG_2013_Brahmi_Mobile_Communications-.pdf>

[Non-Patent Literature 2] “ARIB 2020 and Beyond Ad Hoc Group White Paper Mobile Communication Systems for 2020 and beyond Version 1.0.0, October 8, 2014” Internet [Search on Jul. 1, 2015] <URL: http://www.arib.or.jp/english/20 bah-wp-100.pdf>

### SUMMARY

As described above, the following may be listed as a specific performance required for a 5G network:

Data communication speed;
Power saving performance;

### Scalability;

Ultra low delay (ultra low latency), and so forth.

However, these are usually conflicting other and it is difficult to satisfy all the performance requirements at the same time.

For example, in an M2M device, or the like, a low delay, life elongation of a battery mounted in the device and low cost are required. However, in a case where a delay (latency) of a radio section is to be shortened (for example, the delay is 1 ms (millisecond) or less), a power consumption increases, as a result of which a battery life may become shortened, and a cost may increase.

In order to satisfy a performance requirement(s) required by a communication service to be provided, resources of a RAT (for example, available frequency bandwidth, location registration area, paging channel, random access channel, broadcast information, and so forth) are preferably optimally designed.

Therefore, in the coming 5G, it is desirable to use a plurality of RATs different each to other and suited for each service and purpose to be used.

The present invention has been made in view of the above issues, and its main object is to provide a communication system, a terminal, a base station, a communication control method, each of which enables proper use of RAT, out of a plurality of RATs, suitable for each service and purpose to be used.

According to one aspect of the present invention, there is provided a communication system comprising a radio access network including a plurality of radio access technologies (RAT (Radio Access Technology)), the system comprising:

a first RAT for an initial access by a terminal; and

at least one individual RAT different from the first RAT, wherein

switching from the first RAT to the individual RAT is performed for subsequent processing after the initial access, in accordance with a service to be provided to the terminal.

According to another aspect of the present invention, there is provided a terminal adapted to connect to a radio access network including a plurality of radio access technologies (RAT (Radio Access Technology)), wherein the radio access network comprises:

a first RAT for initial access by the terminal; and

at least one individual RAT different from the first RAT, the terminal comprising:

a unit that performs an initial access with the first RAT; and

a unit that switches from the first RAT to the individual RAT, for subsequent processing after the initial access, in accordance with a service provided from the radio access network to the terminal.

According to another aspect of the present invention, there is provided a base station connecting to a radio access network including a plurality of radio access technologies (RAT (Radio Access Technology)), comprising:

a first RAT for initial access by a terminal;

at least one individual RAT different from the first RAT; and

a unit that switches from the first RAT to the individual RAT for subsequent processing after the initial access, in accordance with a service to be provided to the terminal.

According to still another aspect of the present invention, there is provided a communication control method in a communication system including a radio access network including a plurality of radio access technologies (RAT (Radio Access Technology)), wherein the radio access network comprises:

a first RAT for an initial access by the terminal; and

at least one individual RAT different from the first RAT, the method comprising

switching from the first RAT to the individual RAT for subsequent processing after the initial access, in accordance with a service to be provided to the terminal.

According to still another aspect of the present invention, there is provided a communication control method by a terminal adapted to connect to a radio access network including a plurality of radio access technologies (RAT), wherein the radio access network comprises:

a first RAT for initial access by the terminal; and

at least one individual RAT different from the first RAT, the method comprising:

switching from the first RAT to the individual RAT for subsequent processing after the initial access, in accordance with a service provided from the radio access network to the terminal.

According to another aspect of the present invention, there is provided a communication control method by a base station connecting to a radio access network including a plurality of radio access technologies (RAT); wherein the radio access network comprises:

a first RAT for initial access by the terminal; and

at least one individual RAT different from the first RAT, the method comprising

switching from the initial access to the individual RAT for subsequent processing after the initial access, in accordance with a service to be provided to the terminal.

According to the present invention, proper use of a plurality of RATs suitable for each service and purpose to be used can be contributed selectively.

Still other features and advantages of the present invention will become readily apparent to those skilled in this art from the following detailed description in conjunction with the accompanying drawings wherein only exemplary embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram schematically illustrating an example of a system according to an example embodiment of the present invention.

FIG. 2 is a diagram illustrating an operation example of the example embodiment of the present invention.

FIG. 3 is a diagram illustrating an example of a sequence of the example embodiment of the present invention.

FIG. 4 is a diagram schematically illustrating an example of a configuration of a terminal according to the example embodiment of the present invention.

FIG. 5 is a diagram illustrating an operation example of a terminal according to the example embodiment of the present invention.

FIG. 6 is a diagram schematically illustrating an example of a configuration of a base station according to the example embodiment of the present invention.

### DETAILED DESCRIPTION

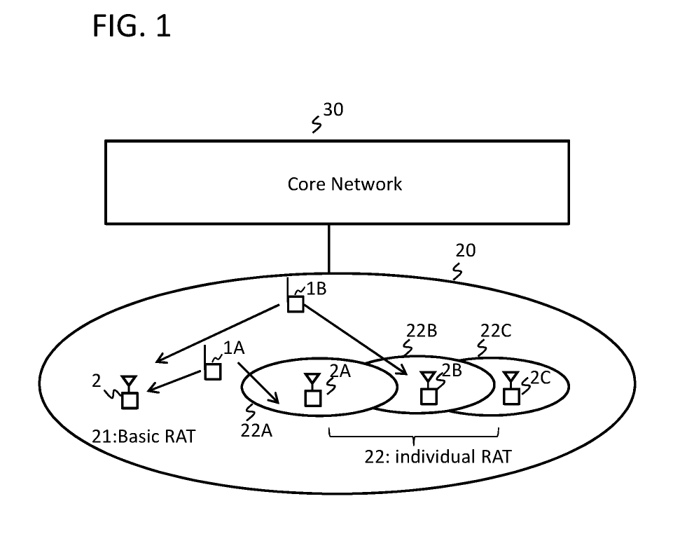

The following describes example embodiments of the present invention with reference to drawings. According to one aspect of the present invention, there is provided a radio access network (for example, 20 in FIG. 1) comprising first to Nth radio access technologies (RATs), where N is a predetermined integer greater than or equal to 2, wherein the first RAT is a basic RAT (for example, 21 in FIG. 1) that provides a common function(s) for an initial access by a terminal, and at least of a second to Nth RATs are composed of individual RATs different from the first RAT (for example, 22A to 22C in FIG. 1). For a terminal supporting the first RAT and at least one individual RAT, in accordance with a service provided to the terminal, processing after the initial access is switched from the first RAT to the individual RAT.

According to one of the several modes of the invention, the switching to the individual RAT may be executed on an initiation of communication from the terminal to the individual RAT;

on an initiation of transmission by the terminal to the individual RAT;

on an initiation of a standby state on the individual RAT; or

on reception by the terminal of predetermined information from the individual RAT.

Each of the individual RATs may include at least one of a paging channel and a random access channel respectively corresponding to a use purpose of the terminal.

According to one of modes of the present invention, the terminal may be in a standby state on the individual RAT.

According to one of the several modes of the present invention, predetermined processing for each of the individual RATs may not be performed by the individual RAT, but may be performed by the first RAT as the common function.

According to one of several modes of the present invention, at least one of cell search, network selection, cell selection, attach processing, and location registration may be provided in the first RAT as at least part of the common function.

According to one of several modes of the present invention, the terminal may receive information for switching to the individual RAT, wherein the information is notified to the terminal using the first RAT.

According to one of several modes of the invention, the terminal may receive information to indicate whether or not the individual RAT is available, by a current location of the terminal (in a cell of the first RAT), wherein the information is notified to the terminal using the first RAT.

According to one of the several modes of the present invention, the terminal may receive configuration information that includes at least one of a random access channel and a paging channel of the individual RAT, wherein the information is notified to the terminal using the first RAT.

### System Configuration Example

FIG. 1 is a diagram schematically illustrating an example of a system configuration of an example embodiment of the present invention. Referring to FIG. 1, in the present embodiment, a radio access network 20 includes a plurality of RATs. For example, the plurality of RATs are divided into one basic RAT 21 and individual RATs 22.

The basic RAT 21 is a RAT corresponding to provision of a predetermined common function(s). The individual RAT 22 is a RAT with designated resources according to a service provided to the terminal and a use (purpose) of a terminal. For example, the individual RAT 22 may have a configuration specialized in performance and so forth according to each use purpose, such as a RAT for millimeter-waves, a RAT for ultra low latency, a RAT for IoT/M2M, or the like.

For example, since a coverage area of 5G needs to be maximized, the base station 2 supports the basic RAT 21. The terminals 1A and 1B also support the basic RAT 21.

On the other hand, both the terminal 1 and the base station 2 may treat the individual RAT as an optional function. That is, not all terminals and base stations need to support individual RATs. In this case, the terminal 1A/1B can be connected to a core network 30 via the base station 2 of the basic RAT 21 in FIG. 1. Likewise, for example, the base station 2 may be constituted by a base station equipped only with a communication function using the basic RAT 21.

Although not particularly limited, in the example shown in FIG. 1, it is assumed that the basic RAT 21 is a RAT used in the base station 2 of a macro cell and the individual RAT 22 includes three RATs which are used in a macro cell, or used respectively by a plurality of base stations 2A, 2B and 2C of a small cell (RATs of a system different from the basic RAT), and ranges covered by cells of respective RATs are represented by 22A, 22B, and 22C (Note that, in the present specification, reference numerals 22A, 22B, and 22C are also used to designate RATs).

In FIG. 1, two terminals 1A and 1B are illustrated only for drawing convenience's sake, but the number of terminals 1 in an area indicated by the radio access network 20 is, as a matter of course, not limited to that of FIG. 1. The number of the individual RAT 22 is. as a matter of course, not limited to three. For the convenience's sake of explanation, when it is not necessary to particularly distinguish between the terminals 1A and 1B, it is simply referred to as a terminal 1.

In the following description, it is assumed that an individual RAT of the terminal 1A supports the individual RAT 22A of the base station 2A and an individual RAT of the terminal 1B respectively supports the individual RAT 22B of the base station 2B.

The terminal 1 performs an initial access on the basic RAT 21. The initial access is a common function that can be provided on the basic RAT, and may be, for example, at least one of cell search, PLMN (Public Land Mobile Network) selection, and cell selection.

Thereafter, the terminal 1 switches to the individual RAT 22 according to a service provided to the terminal 1 or a use purpose of the terminal 1, and then performs attach/authentication, location registration, call origination and reception of an incoming call (data communication) and so forth.

In the present embodiment, resources are individually specialized (optimized) in the individual RAT 22A-22C of the base station 2A-2C.

Specifically, at least a part of a paging channel (PCH) and a random access channel (RACH) having different configurations to be individually specialized (optimized) are individually provided by respective individual RATs 22A-22C.

The terminal performs a random access, when the terminal performs connection establishment with the base station, such as when the terminal 1 originates a call. The terminal 1 transmits a preamble randomly selected from a plurality of preambles which are prepared in a cell. The base station returns a response (RACH response) upon detecting the preamble. The terminal 1, on reception of the response, transmits an RRC (Radio Resource Control) Connection Request to the base station. The base station transmits an RRC Connection Setup message to the terminal 1. If a terminal ID is not included in the message, the terminal 1 determines that the random access fails and retries the random access from transmission of a preamble. When the message includes the terminal ID, the terminal 1 terminates the random access processing and establishes a connection with the base station. Channel information of the RACH for the terminal 1 to establish a connection with any one of the base stations 2A-2C of the individual RAT 22A-22C is notified from the base station 2 of the basic RAT 21 to the terminal 1.

In the present embodiment, the terminal 1 is in a standby state using a PCH and a RACH of the individual RAT 22. It is possible to realize performance (high-speed data transmission speed, low latency, power saving performance, etc.) according to a service provided to the terminal 1 or an individual use (purpose) of the terminal 1. However, depending on a use of the terminal 1, the function of the basic RAT may be partially utilized. For example, the terminal 1 may enter in a standby state on the basic RAT 21 and switch to the individual RAT 22, when performing a predetermined use (for example, call origination).

Further, in the present embodiment, using the basic RAT 21, the terminal 1 acquires, from the base station 2, information for switching to the individual RAT 22.

According to the present embodiment, in the individual RAT 22, it is possible to optimize radio resources for each service. For example, in a frequency band of 10 GHz (Giga Herz) or higher including millimeter-waves, a wavelength is short such that a radio wave cannot propagate far away. In the present embodiment, this millimeter-wave RAT is realized by a small cell (for example, 22A in FIG. 1). Ultra low latency RAT and IoT/M2M RAT are also realized using small cells (for example, 22B and 22C in FIG. 1).

Since both the terminal 1 and the base station 2 support the basic RAT 21, the base station 2 can provide a service to the terminal 1 even outside an area covered by the individual RAT 22. However, when the basic RAT is used, there may be no guarantee that the performance that can be realized by the individual RAT 22 (for example, power saving performance) can be provided.

In the present embodiment, by sharing the basic RAT 21 with a plurality of individual RATs 22A to 22C, basic processing such as cell search and cell selection can be made common.

For example, by performing basic processing (that is, an initial access), such as cell search, PLMN selection, cell selection and so forth between the terminal 1 with the base station 2, using the basic RAT 21, design of the terminal 1 (for example, idle mode processing such as RRC idle state) can be simplified.

Further, in the present embodiment, since a network side can share resources such as broadcast information, radio resources can be saved.

Furthermore, in the present embodiment, the basic RAT 21 and the individual RATs 22 are not managed separately as completely different RATs, but the basic processing is made common to the individual RATs 22, thereby having an advantage to be able to simplify mobile network maintenance and operation management (for example, design of broadcast information).

In 5G, virtualization of radio access network resources is expected to progress with use of a C-RAN (Centralized Radio Access Network) technology.

In the present embodiment, the common function is provided by the basic RAT 21 and one or a plurality of individual RATs 22A to 22C constitute the radio access network, as a result of which scalability (extensibility) of a network may be facilitated with use of virtualization technology (for example, Network Function Virtualization (NFV)), in which great increase of resources (for example, VM (Virtual Machine) instances) of a specific individual RAT can be accommodated.

In FIG. 1, in a case where the core network 30 connected to the radio access network 20 is an evolved packet core (EPC), there are provided an MME (Mobility Management Entity (not shown)) that performs mobility management and authentication of the terminal 1, an SGW (Serving GateWay) (not shown) that performs transmission/reception of user data to/from the base station 2 and setting/release of a communication path with a not-shown PGW (PDN (Packet Data Network) GateWay), a PGW that performs connection to a packet data network (PDN) such as the Internet, assignment of an IP address (private IP address) to the terminal 1, and so forth.

### Example of Operation of Terminal

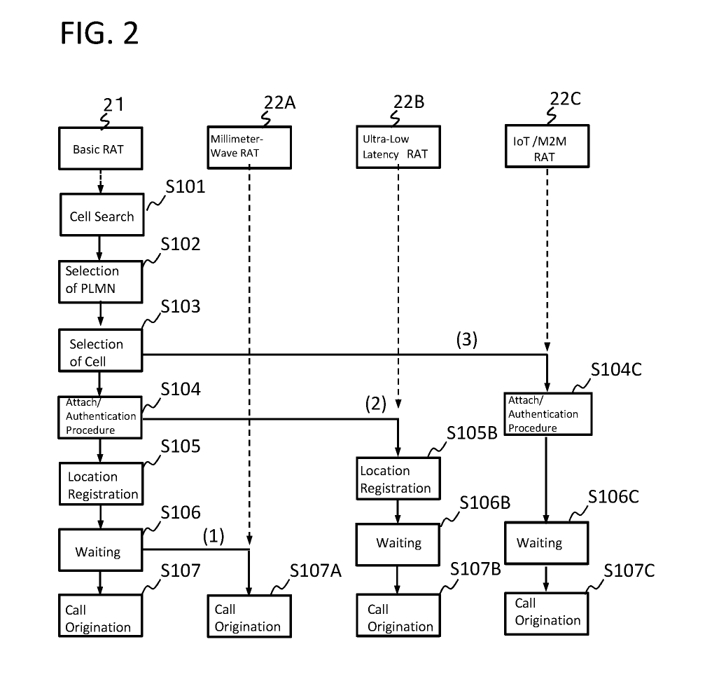

FIG. 2 is a diagram illustrating an example of an operation of the terminal described with reference to FIG. 1. The terminal 1 supports the basic RAT 21, receives a downlink signal (synchronization signal, broadcast channel, broadcast information) from a cell of the basic RAT 21, and based on the information received, performs cell search (step S101), PLMN selection (step S102), and cell selection (step S103). Operations in steps S101 to S103 may be referred to as an initial access (operation for the initial access) provided by the basic RAT.

In the cell search (step S101), the terminal 1 measures a reception level of a serving cell, one or more neighboring cells (for example, peripheral macrocell(s) or small cell(s)), and selects a usable frequency and a candidate cell. A received power level, a received signal strength indication (RSSI), a received signal code power (RSCP), a signal to noise ratio (SNR), a signal to interference ratio (SIR), Ec/No (Energy per Chip to Noise Ratio), RSRP (Reference Signal Received Power), RSRQ (Reference Signal Received Quality), or the like.

In the PLMN selection (step S102), the terminal 1 selects an available network (PLMN) from candidate cells. In the cell selection (step S103), the terminal 1 receives broadcast information of the selected PLMN and detects an available cell. In this case, a macrocell of the basic RAT 21 is selected. In the case of LTE, the terminal 1 identifies a PCI (Physical Cell ID) of a cell by primary synchronization signals and secondary synchronization signals received from the cell at a time of the cell search, and the terminal 1 receives CRS (Cell-specific reference signals) based on the PCI.

In the present embodiment, all the terminals 1A and 1B in a cell can simultaneously use resources of a synchronization signal, a broadcast channel and broadcast information that are transmitted from the base station 2 and used for the cell search. Therefore, a required amount of resources does not increase nor decrease, depending on the number of terminals.

At this stage (step up to the step S103 in FIG. 2), no uplink signal nor traffic from the terminal 1 side occurs. Therefore, uplink resources are not consumed in proportion to the number of terminals.

In the present embodiment, whether or not the individual RAT 22 can be used at a current position of the terminal 1 is notified by broadcast information of a cell of the basic RAT 21. A new type of a SIB (System Information Block) which is a transmission unit of broadcast information in LTE or WCDMA (registered trademark: Wideband Code Division Multiple Access) may be added and capability information on a network side of the individual RAT 22 (NW (Network) capability) may be notified to the terminal using the SIB.

The terminal 1 is generally configured to recognize its own (available) use. For example, the terminal 1 (1C) recognizes that it is a sensor node terminal. A controller, or the like provided in the terminal 1 may recognize the use from device information (configuration) set in a storage apparatus (for example, a nonvolatile storage apparatus such as EE-PROM (Electrically Erasable Programmable Read-Only Memory)) in the terminal 1. Alternatively, a user of the terminal 1 may select in advance which individual RAT 22 to use, for example, on a setup screen of the terminal 1, or the like, and store information of the selected individual RAT 22 in a storage apparatus in the terminal 1.

The terminal 1 may determine whether or not an individual RAT (for example, millimeter-wave RAT, or IoT/M2M RAT) according to a service provided to the terminal 1 or use thereof, based on information transmitted from the base station 2 of the basic RAT 21. Assuming that capability information (NW capability) includes information indicating at least one of millimeter-wave RAT, super latency RAT, IOT/M2M RAT (for example, information element, or flag) as the individual RAT 22 (FIG. 1). When obtaining an information element indicating an individual RAT (for example, a millimeter-wave RAT), the terminal 1 recognizes that the individual RAT is usable, switches from the basic RAT 21 to the individual RAT 22 and performs processing with the individual RAT 22.

It is noted that in the basic RAT 21, attach/authentication by a terminal (step S104), location registration (step S105), waiting (step S106), call origination (step S107), and the like may be performed. In FIG. 2, processing after step S104, as a matter of course, is not limited to the order as illustrated.

In the case of LTE, when a terminal (User Equipment: UE) transmits an attach request to a base station (eNodeB) in the attach/authentication (step S104), the request is forwarded to an MME of the core network, and the MME performs authentication and so forth. The MME makes a location registration request to an HSS (Home Subscriber Server), and the MME further makes a bearer setting request to an SGW in order to set a path to a PDN. The SGW makes a path setting request to the PGW. The PGW performs setting of a path, further assigns an IP (Internet Protocol) address to the terminal, and returns a response to the SGW. In response thereto, the SGW returns a bearer setting response to the MME, which sends a context setting request to the base station (eNodeB). The base station (eNodeB) sets a wireless data link and transmits an attach completion notification to the terminal. The terminal transmits an attach completion notification response to the MME.

In addition, when the terminal 1 in an RRC idle state detects that the terminal 1 has moved across location registration areas (in case of LTE, TA (Tracking Area), while in case of W-CDMA, RA (Routing Area)), the terminal 1 transmits a message TAU (Tracking Area Update) or RAU (Routing Area Update) for updating location registration information to MME or SGSN (Serving GPRS (General Packet Radio Service) Gateway) in the core network 30 in FIG. 1 (location registration in step S105).

A waiting state (step S106) corresponds to an RRC idle state in LTE, a CELL_PCH (paging channel) state in UTRAN (Universal Mobile Telecommunications System) Terrestrial Radio Access Network (UTRAN), or a UTRA (UTRAN Registration Area) _PCH state. The terminal 1 in the waiting state is incapable of transmitting and receiving user data and performs discontinuous reception (DRX) of the paging channel including the paging message transmitted from the radio access network 20.

In a case where the terminal 1 is a millimeter-wave RAT compliant terminal, when making a call from a waiting state, the terminal 1 switches from the basic RAT 21 to the millimeter-wave RAT 22A ((1) in FIG. 2) and performs calling (step S107A) or the like.

Alternatively, in a case where the terminal 1 is an ultra low latency RAT compliant terminal, the terminal 1 switches from the basic RAT 21 to the ultra low latency RAT 22B ((2) in FIG. 2) and performs location registration (step S105B), waiting (step S106B), call origination (step S107B), and so forth. The reason is as follows. There is a possibility that a physical channel (PRACH) of a random access channel (RACH) of the ultra low latency RAT 22B may have a configuration different from that of the basic RAT 21. Therefore, in the location registration (step S105B), the terminal 1 establishes a connection with the base station 2B using a random access channel of the RAT 22B and transmits to the base station 2B a message of the location registration area update (for example, TAU).

In a case where the terminal 1 is an IoT/M2M RAT compliant terminal, the terminal 1, before performing an attach/authentication procedure (step S104C), switches from the basic RAT 21 to the IOT/M2M RAT 22C ((3) in FIG. 2) and performs the attach/authentication procedure (step S104C), waiting (step S106C), call origination (step S107C), and so forth. In the example of FIG. 2, when the IoT/M2M RAT compliant terminal does not move, a location registration (for example, TAU of LTE) due to movement of the terminal or the like is not performed.

In FIG. 2, at least operations in steps S101 to S103 may be referred to as initial access (operation for) provided by the basic RAT.

As described above, the initial access may include common functions that can be provided on the basic RAT, which may be at least one of cell search, PLMN (Public Land Mobile Network) selection, and cell selection, but not limited thereto. For example, the initial access may also include a state and a procedure other than procedures that the individual RAT(s) can provide. For example, in a case where the individual RAT is a millimeter-wave RAT as shown in FIG. 2, the initial access includes an attach/authentication procedure (step S104), a location registration procedure (step S105), and waiting in an idle state (Step S106).

Further, an optimum timing for switching from the basic RAT 21 to an individual RAT 22 in the terminal 1 differs depending on the individual RAT.

Following describes examples of three individual RATs (for example, applicable as 22A-22C in FIG. 1). However, the individual RAT is, as a matter of course, not limited to the following examples.

### IoT/M2M RAT

In the 5G, there is a possibility to provide a so-called “Massive M2M (Machine to Machine) service” that accommodates a large number of sensor nodes, or the like.

A terminal that uses this service may have features such as ultra low power consumption and ultra-low mobility. Therefore, in the individual RAT accommodating this service, it is desirable to design a random access channel capacity to be a large enough so as to withstand access from a large number of sensor nodes, but not limited thereto.

Further, the terminal may randomly select one random access channel from among a plurality of random access channels so that accesses do not concentrate on a specific random access channel all at once.

Alternatively, in order to periodically notify a network of an uplink signal (Keep Alive signal) in order to notify that the terminal 1 is in operation, a notification period of the uplink signal may be changed at random. In this individual RAT, the terminal 1 may wait by at a very long paging cycle. Alternatively, the terminal 1 may not wait.

Reduction of power consumption in the terminal 1 can be realized with a use of a paging channel having a very long paging cycle.

Further, when the terminal 1 does not wait on the individual RAT 22, this individual RAT 22 does not require a paging channel. Instead, the terminal 1 may receive and process a downlink channel only at a timing when the terminal 1 notifies a Keep Alive signal, and at that timing, a base station of the individual RAT transmits a downlink message to the terminal 1. This configuration enables reduction of power consumption in the terminal 1.

### Ultra-Low Latency RAT

In 5G, there may be a case supporting so-called “Critical M2M service” requiring a very short delay time (such as delay: 1 ms or less) such as telemedicine, drone maneuvering, industrial communication, etc. In the individual RAT accommodating this service, it is desirable to design a random access channel capacity to be large in order to shorten a channel establishment time, though not limited thereto.

In order to increase a speed of incoming call processing, such a configuration may be adopted, in which by allocating a very short paging cycle and increasing a transmission speed of the paging channel, a paging signal can be received in a short time. As a result, power saving of the terminal can be realized.

### Millimeter-Wave RAT

In 5G, there is a possibility of providing a so-called “Massive Broadband service” that extends a transmission speed of a wireless broadband service performed in 4G, for example, several tens of times to several hundred times. For this reason, it is studied to utilize microwave (especially millimeter-wave) which can widely guarantee a unused frequency bandwidth.

### Operation of Millimeter-Wave RAT Support Terminal

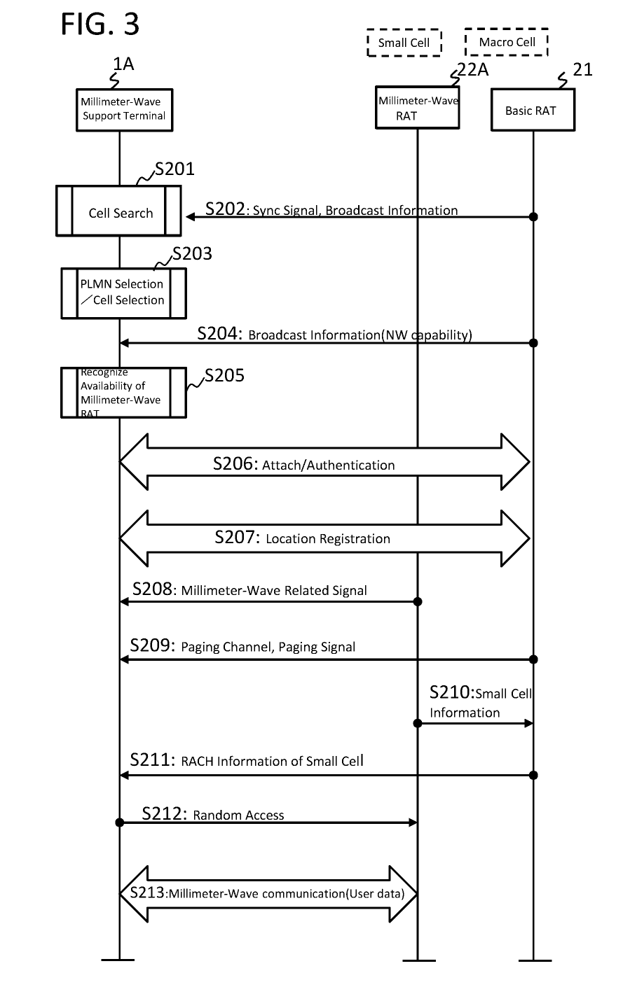

FIG. 3 is a diagram illustrating an example of an operation sequence of a millimeter-wave RAT support terminal (for example, 1A in FIG. 1). In FIG. 3, S201, S202, etc., indicate order of steps in FIG. 3. However, the numbers are allotted only for the sake of convenience and do not mean that an operation is performed in this order.

In a cell search (step S201), a synchronization signal and broadcast information are transmitted from a base station 2 of the basic RAT 21 (step S202). In LTE, PSS (Primary Synchronization Signal), SSS (Secondary Synchronization Signal), and RS (Reference Signal) are included as downlink physical signals used in the cell search. The broadcast information includes MIB (Master Information Block), for example.

In the terminal 1A, PLMN selection/cell selection is performed (step S203).

The terminal 1A receives network capability information (NW capability) in broadcast information notified from the base station 2 of the basic RAT 21 in an RRC idle state, for example (step S204). The capability information (NW capability) of the network may be broadcasted by SIB (System Information Block) in the base station 2 of the basic RAT 21. In that case, an SIB type (Type) for notifying capability information of the network may be newly provided.

In a case where the received network capability information (NW capability) includes a millimeter-wave RAT, the terminal 1A recognizes that the millimeter-wave RAT 22A can be used (step S205).

The terminal 1A that uses this service performs an attach/authentication procedure in the basic RAT 21 (step S206). When the terminal 1A moves in an idle state (RRC idle), the terminal 1A performs location registration (for example, TAU of LTE) (step S207).

It is noted that the base station 2A of a millimeter-wave RAT periodically notifies millimeter-wave related information using a broadcast channel, for example (step S208). The base station 2A of a millimeter-wave RAT may broadcast millimeter-wave related information using a synchronization signal.

For example, the terminal 1A observes a downlink signal of a small cell (for example, a cell of a millimeter-wave RAT) during a waiting period in a macro cell, and constantly (for example, periodically or regularly) measure a reception angle of a millimeter-wave. By performing such measurement, the terminal 1A make preparation to make an uplink access to a small cell (for example, cell of RAT for millimeter-wave) at any time.

Further, the terminal 1A is in a waiting state on the basic RAT 21. The terminal 1A receives information (for example, paging channel, paging signal) for starting communication in the millimeter-wave RAT 22A from the basic RAT (step S209).

In the present embodiment, since the basic RAT 21 is used in common with other services, a macro cell using a relatively low frequency is assumed to be used, instead of a high frequency band such as a millimeter-wave or the like.

The millimeter-waves have, due to a characteristic of strong recti-linearity, receive a great influence of shadowing/scattering, and have a large propagation loss due to atmospheric/rainfall or the like. For this reason, it is desirable that millimeter-wave communication is performed using a small cell with a small area radius.

On a network side, an integrated operation of a macro cell and a millimeter-wave small cell is performed and information on configuration of random access channel of a small cell (for example, PRACH (Physical RACH) Configuration Index, and so forth) is notified by a broadcast channel or a dedicated channel provided by the macro cell of basic RAT 21 (Base station 2) (step S211).

In FIG. 3, the base station 2A for the millimeter-wave RAT notifies the base station 2 of the basic RAT 21 of small cell information (for example, configuration related to a small cell) (step S210). However, the notification in step S210 is not necessarily performed at this timing and sequence, that is, at any time as long as it is before the base station 2 of the basic RAT 21 transmits channel information (configuration) of RACH of the small cell to the terminal 1 (step S211).

When starting communication, the terminal 1A performs uplink access using a random access channel provided by a small cell managed by the base station 2A of the millimeter-wave RAT 22A (step S212).

After establishing a connection with the base station 2A of the millimeter-wave RAT 22A by a random access, the terminal 1A performs user data transfer using millimeter-wave communication (step S213).

Further, in FIG. 3, the operations in steps S201 to S207, S209, and S211 may be referred to as an initial access (operation for an initial access) provided in the basic RAT.

As described above, the initial access is a common function that can be provided on the basic RAT. The initial access may be at least one of cell search, PLMN (Public Land Mobile Network) selection, and cell selection, but not limited thereto. For example, the initial access may also include a state and a procedure and other than procedures that an individual RAT(s) can provide. For example, in a case where the individual RAT is a millimeter-wave RAT as shown in FIG. 3, the initial access may include reception of notification information performed with the basic RAT, an attach/authentication procedure, a location registration procedure, waiting in an idle state, reception of paging channel, and a paging signal, and reception of RACH information of a small cell(s) (individual RAT(s)).

Techniques such as GSM (registered trademark), W-CDMA, IEEE (Institute of Electrical and Electronics Engineers, Inc.) 802.11ah and the like are also applicable as examples of individual RATs other than those mentioned above.

However, since the terminal 1 is needed to have a basic RAT function, a terminal such as an existing GSM (registered trademark) terminal, a W-CDMA terminal, and an IEEE 802.11ah terminal may not be used as it is.

In the present embodiment, at a current location of the terminal 1, when an individual RAT (for example, IoT/M2M RAT) matching use (for example, sensor node terminal) is not available, the terminal 1 that supports the basic RAT, performs an attach/authentication procedure and a location registration, using functions of the basic RAT.

That is, there is an advantage that a service can be provided within an area covered by the basic RAT 21. However, in this case, the terminal 1 may not be able to benefit from an optimized resource design (individual RAT function).

When the terminal 1 cannot use the individual RAT (22 in FIG. 1) and receives a service only from the basic RAT (21 in FIG. 1), there may occur disadvantages in which a network side cannot accommodate a sufficient number of terminals, or power saving performance of the terminal 1 may be reduced. However, it is expected that such disadvantages would be solved with an investment in network infrastructures and addition of functions of individual RAT by a telecommunication carrier according to needs.

### Configuration of Terminal

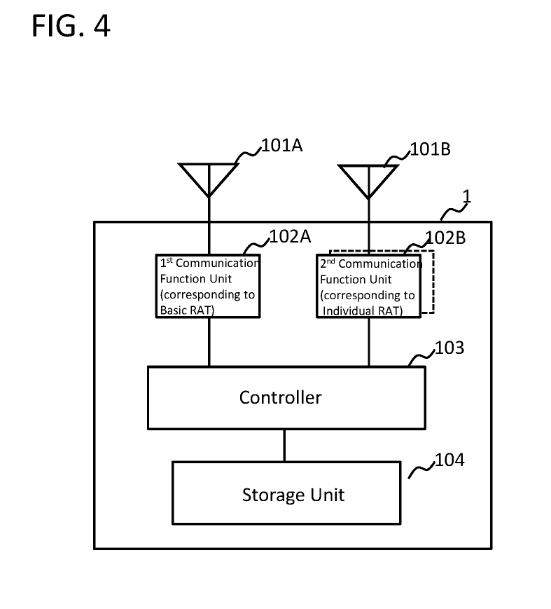

FIG. 4 is a diagram illustrating a configuration (control system) of the terminal in FIG. 1. The configuration of the control system of the terminals 1A and 1B in FIG. 1 can be schematically illustrated as a common block configuration. Referring to FIG. 4, the terminal 1 includes a first communication function unit 102A and a second communication function unit 102B connected respectively to antennas 101A and 101B, a first communication function unit 102A and a second communication function unit 102B, a controller 103 that controls the operation of the apparatus, and a storage apparatus 104.

The first communication function unit 102A communicates with the basic RAT 21 of a radio access network with the basic RAT function (for example, cell search, PLMN selection, cell selection, notification information reception (NW capability), paging channel of an individual RAT, channel information of RACH), an attach processing/authentication processing, etc.). The second communication function unit 102B provides a function corresponding to the individual RAT. The second communication function unit 102B may have a configuration including a plurality of communication function units respectively corresponding to individual RATs having different uses (represented by broken lines in FIG. 4).

The control unit 103 monitors a sequence operation in the first communication function unit 102A. In such a situation that the first communication function unit 102A receives, from the base station 2 of the basic RAT 21, switching information from the basic RAT to the individual RAT, when detecting that an operation performed next by the first communication function unit 102A is a sequence (a sequence of (1), (2), or (3) in FIG. 2) corresponding to switching to the individual RAT (that is, a procedure that can provide an individual RAT), switching from the first communication function unit 102A (basic RAT) to the second communication function unit 102B (individual RAT) is performed. When a power is turned on or the like, the control unit 103 selects the first communication function unit 102A. The control unit 103 may monitor exchange of signals with the base station 2 (see FIG.

1) of the basic RAT in the first communication function unit 102A. The storage unit 104 includes, for example, a RAM (Random Access Memory), a ROM (Read Only Memory), an EEPROM (Electrically Erasable Programmable Read Only Memory), or the like. The storage unit 104 may store information on a preset paging channel, random access channel, and the like of the individual RAT.

It is noted that functions and processes of the control unit 103 of FIG. 4 may be implemented by a program executed by a computer (processor) constituting the control unit 103. In this case, the program may be stored, in the storage unit 104, for example, and is read and executed by the computer (processor) constituting the control unit 103.

### Example of Operation of Terminal

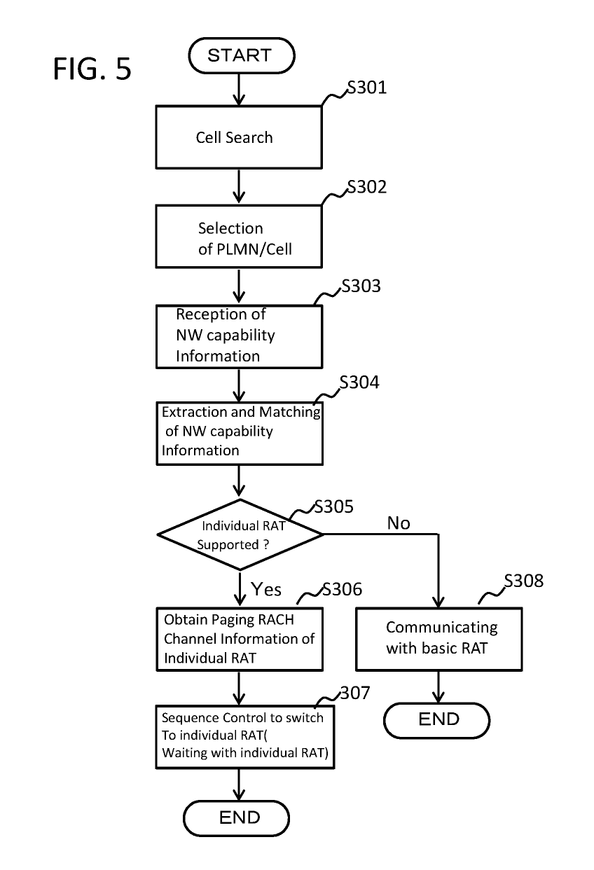

FIG. 5 is a flowchart illustrating the operation of the terminal 1 of FIG. 4. In the terminal 1, when a power supply is turned on, the first communication function unit 102A performs cell search and PLMN selection/cell selection (steps S301 and S302), and receives network capability information (NW Capability) (step S303). The first communication function unit 102A is configured to receive broadcast information (SIB) including, for example, network capability information when the terminal 1 is in an RRC idle state. The control unit 103 extracts the network capability information and checks whether an individual RAT supported by the terminal 1 is included in the network capability information (step S304).

In a case where an individual RAT is included in the network capability information (NW Capability) and the terminal 1 supports the individual RAT (Yes branch of step S305), the control unit 103, if paging and random access channel (RACH) information of the individual RAT are set in the storage unit 104, obtains paging and random access channel information (step S306). Although not particularly limited, the terminal 1 may wait in an RRC idle state until paging and random access channel (RACH) information of the individual RAT is notified from the base station 2 (FIG. 1). When receiving paging and random access channel (RACH) information of the individual RAT, the terminal 1 may store the paging and random access channel (RACH) information in the storage unit 104. When an operation in the first communication function unit 102A corresponds to a sequence of switching from the basic RAT to the individual RAT (that is, the terminal 1 can execute a procedure that can be provided by the individual RAT, the control unit 103 may instruct the switching unit 103 to perform switching (step S307). After that, for example, the terminal 1 turns into a waiting state on the individual RAT.

On the other hand, when the individual RAT is included in the received network capability information (NW capability), and the terminal 1 doesn't support the individual RAT, or when the individual RAT is not included in the network capability information (NW capability) (No branch of step S305), the terminal 1 continues the communication on the basic RAT (the first communication function unit 102A) as it is (step S308).

In FIG. 5, after the terminal 1 has performed communication with the second communication function unit 102B of the individual RAT, and when a cell search is again required (excluding handover), processing is performed from that of the step S301 (cell search by the basic RAT). In addition, in FIG. 5, the operations in steps S301 to S306 may be referred to as an initial access (operations for an initial access) provided by the basic RAT.

### Example of Configuration of Base Station

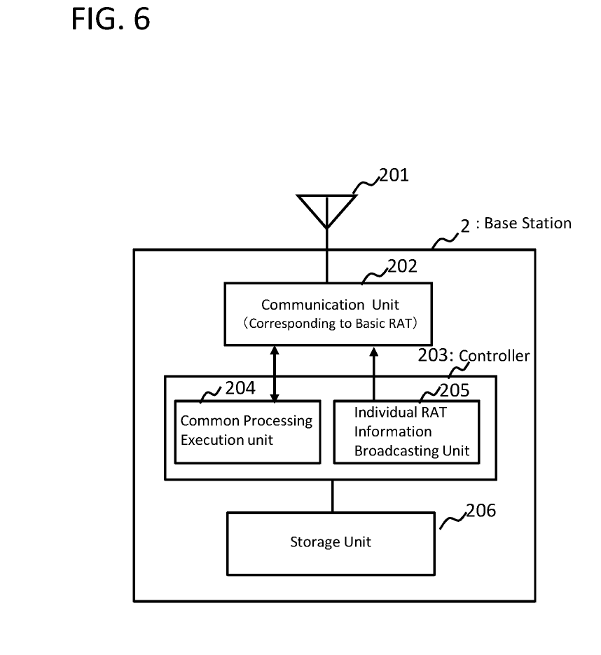

FIG. 6 is a diagram illustrating a configuration of the base station 2 of the basic RAT. Referring to FIG. 6, the base station 2 includes an antenna 201, a communication unit 202 that communicates with a basic RAT, a control unit 203, and a storage unit 206. The control unit 203 includes a common processing execution unit 204 that provides, via the communication unit 202, processing (service) corresponding to a common function (for example, cell search, PLMN selection, cell selection, etc., in the terminal) to a terminal (not shown), an individual RAT information informing unit 205 that makes from the communication section 202 notify a terminal (not shown) of information (for example, NW capability, paging channel of the individual RAT, random access channel information) for the terminal to switch to the individual RAT. The storage unit 206 stores information of the terminal 1 and the like, when the common process execution unit 204 stores, for example, executes an attach processing from the terminal. Note that the storage unit 206 includes a semiconductor memory such as a RAM (Random Access Memory), a ROM (Read Only Memory), an EEPROM (Electrically Erasable Programmable Read Only Memory), and a HDD (Hard Disk Drive).

It is noted that functions of the common process executing unit 204 and the individual RAT information notification unit 205 of the control unit 203 in FIG. 6 may be realized by a program executed by a computer constituting the base station 2. In this case, the program may be stored in the storage unit 206, for example, and may be read and executed by a computer (processor) constituting the control unit 103.

Although not particularly limited, the base station of the basic RAT (for example, 2 in FIG. 1) and the base station of the individual RAT (for example, 2A-2C in FIG. 1) may be mounted as one unit. The base stations of two or more individual RATs may as a matter of course be implemented as one unit.

The above-described embodiment may be attached as follows (though not limited to the following).

### Supplementary Note 1

A communication system comprising a radio access network including a plurality of radio access technologies (RAT (Radio Access Technology)), the system comprising:
a first RAT for an initial access by a terminal; and
at least one individual RAT different from the first RAT, wherein
switching from the first RAT to the individual RAT is performed for subsequent processing after the initial access, in accordance with a service to be provided to the terminal.

### Supplementary Note 2

The communication system according to supplementary note 1, wherein the switching to the individual RAT is performed on any one of starting transmission from the terminal to the individual RAT; starting a waiting state at the individual RAT by the terminal; and reception by the terminal of predetermined information from the individual RAT.

### Supplementary Note 3

The communication system according to supplementary note 1 or 2, wherein each individual RAT includes at least one of a paging channel and a random access channel respectively corresponding to usage of the terminal.

### Supplementary Note 4

The communication system according to any one of supplementary notes 1 to 3, wherein processing predetermined for each individual RAT, is not performed in the individual RAT but is performed in the first RAT as a common function.

### Supplementary Note 5

The communication system according to any one of supplementary notes 1 to 3, wherein at least one of cell search, network selection, cell selection, attach processing, and location registration is provided as the common function in the first RAT.

### Supplementary Note 6

The communication system according to any one of supplementary notes 1 to 5, wherein information for switching to the individual RAT, is notified to the terminal by using the first RAT.

### Supplementary Note 7

The communication system according to any one of supplementary notes 1 to 6, wherein information as to whether or not the individual RAT is available at a current position of the terminal, is notified to the terminal by using the first RAT.

### Supplementary Note 8

The communication system according to any one of supplementary notes 1 to 7, wherein information of at least one of a random access channel and a paging channel of the individual RAT is notified to the terminal by using the first RAT.

### Supplementary Note 9

A terminal adapted to connect to a radio access network including a plurality of radio access technologies (RAT (Radio Access Technology)), wherein the radio access network comprises:
a first RAT for initial access by the terminal; and
at least one individual RAT different from the first RAT, the terminal comprising:
means for performing initial access with the first RAT; and
means for switching from the first RAT to the individual RAT, for subsequent processing after the initial access, in accordance with a service provided from the radio access network to the terminal.

### Supplementary Note 10

The terminal according to supplementary note 9, wherein the switching to the individual RAT is performed on any one of:
starting transmission from the terminal to the individual RAT;
starting a waiting state at the individual RAT by the terminal; and
reception by the terminal of predetermined information from the individual RAT.

### Supplementary Note 11

The terminal according to supplementary note 9 or 10, wherein each individual RAT includes at least one of a paging channel and a random access channel respectively corresponding to usage of the terminal.

### Supplementary Note 12

The terminal according to any one of supplementary notes 9 to 11, wherein processing predetermined for each individual RAT, is not performed in the individual RAT, but is performed in the first RAT as a common function.

### Supplementary Note 13

The terminal according to any one of supplementary notes 9 to 12, wherein at least one of cell search, network selection, cell selection, attach processing, and location registration is provided as the common function in the first RAT.

### Supplementary Note 14

The terminal according to any one of supplementary notes 9 to 13, wherein information for switching to the individual RAT, is notified to the terminal by using the first RAT.

### Supplementary Note 15

The terminal according to any one of supplementary notes 9 to 14, wherein information as to whether or not the individual RAT is available at a current position of the terminal, is notified to the terminal by using the first RAT.

### Supplementary Note 16

The terminal according to any one of supplementary notes 9 to 15, wherein information of at least one of a random access channel and a paging channel of the individual RAT is notified to the terminal by using the first RAT.

### Supplementary Note 17

A base station provided in a radio access network including a plurality of radio access technologies (RAT (Radio Access Technology)), comprising:
a first RAT for initial access by a terminal;
at least one individual RAT different from the first RAT; and
means for switching from the first RAT to the individual RAT for subsequent processing after the initial access, in accordance with a service to be provided to the terminal.

### Supplementary Note 18

The base station according to supplementary note 17, wherein the switching to the individual RAT is performed on any one of:
starting transmission from the terminal to the individual RAT;
starting a waiting state at the individual RAT by the terminal; and
reception by the terminal of predetermined information from the individual RAT.

### Supplementary Note 19

The base station according to supplementary note 17 or 18, wherein each individual RAT includes at least one of a paging channel and a random access channel respectively corresponding to usage of the terminal.

### Supplementary Note 20

The base station according to any one of supplementary notes 17 to 19, wherein processing predetermined for each individual RAT, is not performed in the individual RAT, but is performed in the first RAT as a common function.

### Supplementary Note 21

The base station according to any one of supplementary notes 17 to 20, wherein at least one of cell search, network selection, cell selection, attach processing, and location registration is provided as the common function in the first RAT.

### Supplementary Note 22

The base station according to any one of supplementary notes 17 to 21, wherein information for switching to the individual RAT, is notified to the terminal by using the first RAT.

### Supplementary Note 23

The base station according to any one of supplementary notes 17 to 22, wherein information as to whether or not the individual RAT is available at a current position of the terminal, is notified to the terminal by using the first RAT.

### Supplementary Note 24

The base station according to any one of supplementary notes 17 to 23, wherein information of at least one of a random access channel and a paging channel of the individual RAT is notified to the terminal by using the first RAT.

### Supplementary Note 25

A communication control method in a communication system including a radio access network including a plurality of radio access technologies (RAT (Radio Access Technology)), wherein the radio access network comprises:
a first RAT for an initial access by the terminal; and
at least one individual RAT different from the first RAT, the method comprising
switching from the first RAT to the individual RAT for subsequent processing after the initial access, in accordance with a service to be provided to the terminal.

### Supplementary Note 26

The communication control method according to supplementary note 25, wherein the switching to the individual RAT is performed on any one of:
starting transmission from the terminal to the individual RAT;
starting a waiting state at the individual RAT by the terminal; and
reception by the terminal of predetermined information from the individual RAT.

### Supplementary Note 27

The communication control method according to supplementary note 25 or 26, wherein each individual RAT includes at least one of a paging channel and a random access channel respectively corresponding to usage of the terminal.

### Supplementary Note 28

The communication control method according to any one of supplementary notes 25 to 27, wherein processing predetermined for each individual RAT, is not performed in the individual RAT, but is performed in the first RAT as a common function.

### Supplementary Note 29

The communication control method according to supplementary note 28, wherein at least one of cell search, network selection, cell selection, attach processing, and location registration is provided as the common function in the first RAT.

### Supplementary Note 30

The communication control method according to any one of supplementary notes 25 to 29, comprising
notifying information for switching to the individual RAT, to the terminal by using the first RAT.

### Supplementary Note 31

The communication control method according to any one of supplementary notes 25 to 30, comprising
notifying information as to whether or not the individual RAT is available at a current position of the terminal, to the terminal by using the first RAT.

### Supplementary Note 32

The communication control method according to any one of supplementary notes 25 to 31, comprising
notifying information of at least one of a random access channel and a paging channel of the individual RAT to the terminal by using the first RAT.

### Supplementary Note 33

A communication control method by a terminal adapted to connect to a radio access network including a plurality of radio access technologies (RAT), wherein the radio access network comprises:
a first RAT for initial access by the terminal; and
at least one individual RAT different from the first RAT, the method comprising:
switching from the first RAT to the individual RAT for subsequent processing after the initial access, in accordance with a service provided from the radio access network to the terminal.

### Supplementary Note 34

A communication control method by a base station connecting to a radio access network including a plurality of radio access technologies (RAT); wherein the radio access network comprises:
a first RAT for initial access by the terminal; and
at least one individual RAT different from the first RAT, the method comprising
switching from the initial access to the individual RAT for subsequent processing after the initial access, in accordance with a service to be provided to the terminal.

### Supplementary Note 35

A program causing a computer constituting a terminal adapted to connect to a radio access network including:
a first RAT for initial access by the terminal; and
at least one individual RAT different from the first RAT, to execute processing including:
switching from the first RAT to the individual RAT for subsequent processing after the initial access, in accordance with a service provided from the radio access network to the terminal.

### Supplementary Note 36

A program causing a computer constituting a base station connecting to a radio access network including:
a first RAT for initial access by a terminal; and
at least one individual RAT different from the first RAT, to execute processing including:
switching from the first RAT to the individual RAT for subsequent processing after the initial access, in accordance with a service provided from the radio access network to the terminal.

### Supplementary note 37

There is provided a computer-readable recording medium in which the program according to supplementary note 35 or 36 is recorded. The recording medium includes a storage such as a semiconductor memory, a magnetic recording medium, a CD (Compact Disk) -ROM (Read Only Memory), or the like.

Each disclosure of the above Patent Literatures 1-3 and Non-patent Literatures 1 and 2 is incorporated herein by reference. Within the framework of the entire disclosure (including the scope of claims) of the present invention, it is possible to change/adjust the embodiments or examples based on basic technical ideas or concepts. Also, various combinations or selections of various disclosed elements (including each element of each claim, each element of each embodiment, each element of each drawing, etc.) are possible within the scope of the claims of the present invention. That is, it goes without saying that the present invention includes various modifications and modifications that could be made by those skilled in the art according to the entire disclosure including the claims, and technical ideas.

### REFERENCE SIGNS LIST

1A, 1B Terminal
2, 2A, 2B, 2C Base station
20 Radio access network
21 Basic RAT
22, 22A, 22B, 22C Individual RAT
101A, 101B Antenna
102A First communication function unit
102B second communication function unit
103 Control unit
104 Storage unit
201 Antenna
202 Communication unit
203 Control unit
204 Common process execution unit
205 Individual RAT information informing section

What is claimed is:

1. A communication system comprising a radio access network including a plurality of radio access technologies (RATs), the system comprising:
a first RAT for an initial access by a terminal; and
at least one individual RAT different from the first RAT, wherein
the system performs switching from the first RAT to the individual RAT for subsequent processing after the initial access, in accordance with a service to be provided to the terminal.

2. The communication system according to claim 1, wherein each individual RAT includes at least one of a paging channel and a random access channel respectively corresponding to usage of the terminal.

3. A terminal adapted to connect to a radio access network including a plurality of radio access technologies (RATs), wherein the radio access network comprises:
a first RAT for initial access by the terminal; and
at least one individual RAT different from the first RAT, the terminal comprising:
a unit that performs an initial access with the first RAT; and
a unit that switches from the first RAT to the individual RAT, for subsequent processing after the initial access, in accordance with a service provided from the radio access network to the terminal.

4. The terminal according to claim 3, wherein the switching to the individual RAT is performed on any one of:
starting transmission from the terminal to the individual RAT;
starting a waiting state at the individual RAT by the terminal; and
reception by the terminal of predetermined information from the individual RAT.

5. The terminal according to claim 3, wherein the individual RAT each includes at least one of a paging channel and a random access channel respectively corresponding to usage of the terminal.

6. The terminal according to claim 3, wherein processing predetermined for each individual RAT is not performed by the individual RAT, but is performed by the first RAT as a common function.

7. The terminal according to claim 3, wherein at least one of cell search, network selection, cell selection, an attach processing, and location registration is provided as the common function in the first RAT.

8. The terminal according to claim 3, wherein the terminal receives information for switching to the individual RAT, the information being notified with a use of the first RAT.

9. The terminal according to claim 3, wherein the terminal receives information as to whether or not the individual RAT is available at a current location of the terminal, the information being notified with a use of the first RAT.

10. The terminal according to claim 3, wherein the terminal receives channel information of at least one of a random access channel and a paging channel of the individual RAT, the channel information being notified with a use of the first RAT.

11. A base station provided in a radio access network including a plurality of radio access technologies (RATs), comprising:
a first RAT for initial access by a terminal;
at least one individual RAT different from the first RAT; and
a unit that switches from the first RAT to the individual RAT for subsequent processing after the initial access, in accordance with a service to be provided to the terminal.

12. The base station according to claim 11, wherein the individual RAT each includes at least one of a paging channel and a random access channel respectively corresponding to usage of the terminal.

13. A communication control method in a communication system including a radio access network including a plurality of radio access technologies (RATs), wherein the radio access network comprises:
a first RAT for an initial access by the terminal,
at least one individual RAT different from the first RAT, the method comprising
switching from the first RAT to the individual RAT for subsequent processing after the initial access, in accordance with a service to be provided to the terminal.

14. A communication control method by a terminal adapted to connect to a radio access network including a plurality of radio access technologies (RATs), wherein the radio access network comprises:
a first RAT for initial access by the terminal; and
at least one individual RAT different from the first RAT, the method comprising:
switching from the first RAT to the individual RAT for subsequent processing after the initial access, in accordance with a service provided from the radio access network to the terminal.

15. A communication control method by a base station connecting to a radio access network including a plurality of radio access technologies (RATs); wherein the radio access network comprises:
a first RAT for initial access by the terminal; and
at least one individual RAT different from the first RAT, the method comprising
switching from the initial access to the individual RAT for subsequent processing after the initial access, in accordance with a service to be provided to the terminal.
